(19) United States
(12) Patent Application Publication
(10) Pub. No.: US 2016/0355290 A1
(43) Pub. Date: Dec. 8, 2016

(54) METHOD AND APPARATUS FOR THE MANUFACTURE OF A PACKAGED PRODUCT

(71) Applicant: MARS, INCORPORATED, MCLEAN, VA (US)

(72) Inventors: SIEGFRIED SCHMIDT, VERDEN (DE); THORSTEN K. KLIMACH, VERDEN (DE)

(73) Assignee: MARS, INCORPORATED, MCLEAN, VA (US)

(21) Appl. No.: 15/160,383

(22) Filed: May 20, 2016

(30) Foreign Application Priority Data
May 22, 2015 (EP) 15168835.5

(51) Int. Cl. B65B 55/18; B65B 63/08; A23L 3/16; B65B 7/16

(52) U.S. Cl. CPC B65B 55/18; B65B 7/16; B65B 63/08; A23L 3/16; A23V 2002/00

(57) ABSTRACT

A method for manufacturing a packed product includes the steps of: a) bringing a product into a superheated steam atmosphere with an O₂ content of maximum 10 vol.-%, a pressure of between 950 mbar and 1100 mbar and a temperature of minimum 100° C., b) making available a packing container in the steam atmosphere and filling the packing container with a predetermined quantity of the product, wherein a residual volume of the packing container not filled with product is filled with the steam atmosphere, c) replacing at least 50% of the residual volume of steam atmosphere in the packing container by a sterile inert gas, d) sealing the packing container, and e) cooling the packing container and the product contained therein to a temperature of between 10° C. and 25° C.

### FIELD

The present disclosure relates generally to a packaged food product and, more specifically, to a food product packaged in an environment of super heated steam.

### BACKGROUND

Food products packaged in an environment of super heated steam may experience uncontrolled condensation of steam remaining in the packing container after sealing, which may affect quality and long term stability of the product.

### SUMMARY

A method for the manufacture of a packed product may, for example, comprise the steps of transporting a product into a superheated steam atmosphere with an O₂ content of less than 10 vol.-%, a pressure of between 950 mbar and 1100 mbar, and a temperature of at least 100° C., providing a packing container in the superheated steam atmosphere and filling the packing container with a predetermined quantity of the product, wherein a residual volume of the packing container not filled with product is filled with the superheated steam atmosphere, replacing at least 50% of the residual volume of superheated steam atmosphere in the packing container with a sterile inert gas, sealing the packing container, and cooling the packing container and the product contained therein to a temperature below 100° C.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figure, wherein like numerals denote like elements.

FIG. 1 illustrates a device for manufacturing a packed product in accordance with various embodiments.

### DETAILED DESCRIPTION

In various embodiments in accordance with the present disclosure, a portion of the steam atmosphere in the packing container may be replacing by an inert gas, which may reduce the potential for the remaining gaseous atmosphere in the container to condense within the packing container after cooling. Further, the production of a negative pressure within the packing container may also be reduced, such as, for example, in embodiments in which a rigid packing container such as a screw-top jar is utilized.

In various embodiments, reducing the condensation of the steam atmosphere within the packaging container may reduce or prevent condensed water from contacting packaged product. Condensed water may cause moisture within the packaged product, as well as an increased a_{w}-value for individual pieces of the packaged product, which may reduce the durability of the product and may permit the growth of bacteria on the product.

The packing container and the product contained therein can be cooled to a temperature below 50° C., 40° C., 30° C., 20° C. or 10° C.

The product can be a food product. The product may be moist before it is brought into the steam atmosphere and have an a_{w}-value of up to 0.9, for example up to 0.8, 0.7, 0.6, 0.5, 0.4 or 0.3.

The product can consist of protein, particularly animal or vegetable protein, and/or cereals. It may be contemplated that the product is extruded directly into the steam atmosphere.

In various embodiments, the product is dried in the superheated steam atmosphere to an a_{w}-value of 0.9 or less, for example, less than 0.8, 0.7, 0.6 or 0.5 before it is filled into the packing container.

For example, the packaging container can comprise a rigid packing container in which a portion of the residual volume of superheated steam atmosphere in the packing container is replaced by the inert gas, and, after cooling to a temperature of 20° C., the container comprises a pressure of less than 500 mbar, 550 mbar, 600 mbar, 650 mbar, 700 mbar, 750 mbar, 800 mbar, 850 mbar, 900 mbar or 950 mbar.

In various embodiments, at least 55%, 60%, 65%, 70%, 75%, 80%, 85%, 90%, 95%, 98% or 99% of the residual volume of superheated steam atmosphere in the packing container is replaced by the inert gas.

The step of replacing at least 50% of the residual volume of superheated steam atmosphere in the packing container with a sterile inert gas, can, for example, be implemented within the superheated steam atmosphere. Further, before the step of replacing the residual volume of superheated steam, the inert gas can be heated to a temperature of at least 60° C., 80° C., 100° C., or to the temperature of the superheated steam atmosphere.

In various embodiments, the sterile inert gas may comprise N₂, CO₂, N₂O, CO, H₂, or mixtures thereof. For example, a mixture of N₂ or CO₂ with at least 10 vol.-%, 20 vol.-%, 30 vol.-%, 40 vol.-%, 50 vol.-%, 60 vol.-%, 70 vol.-%, 80 vol.-% or 90 vol.-% of CO₂ can be used.

Packing containers in accordance with the present disclosure may comprise, for example, a receptacle with screw cap (such as a glass receptacle), a can, and a plastic bag.

In various embodiments, the product can be packed in a superheated steam atmosphere having an O₂ content less than 7.5 vol.-%, 5 vol.-%, 3 vol.-% or 1 vol.-%. Further, the product can be packed in a superheated steam atmosphere having a temperature of at least 110° C., 120° C., 130° C., or 150° C.

Apparatus for carrying out the methods of the present disclosure may comprise, for example, a steam generator for producing the superheated steam atmosphere, a chamber for holding the superheated steam atmosphere, means for making available a packing container in the chamber, transport equipment for transporting product into the chamber, a filling unit for filling the product into a packing container, a gas injector for controlled injection of sterile inert gas into a packing container filled with product and superheated steam atmosphere, a sealing apparatus for sealing the filled packing container, and/or transport equipment for removing the sealed packing container from the chamber. The packing container with the product contained therein may be cooled in a cooling device, such as, for example, a cooling device utilizing a controlled time-temperature profile, or only through contact of the packing container with the environment.

In various embodiments, a gas injector may be disposed within the chamber. The gas injector can comprise, for example, a gas supply pipe, which can be immersed in the packing container such that a gas discharge opening of the gas supply pipe is located at or near the bottom of the container. In such embodiments, when inert gas is injected from the gas discharge opening into the packaging container, residual volume of steam atmosphere is expelled from the packing container. For example, the inert gas may displace steam atmosphere located between individual pieces of the food product, such as food products which are lumpy, granular or granular-type foods having cavities or gaps between the individual pieces. In other embodiments, a gas nozzle may be utilized to provide sterile inert gas into the packing container.

In various embodiments, a sealing apparatus can be disposed within the chamber.

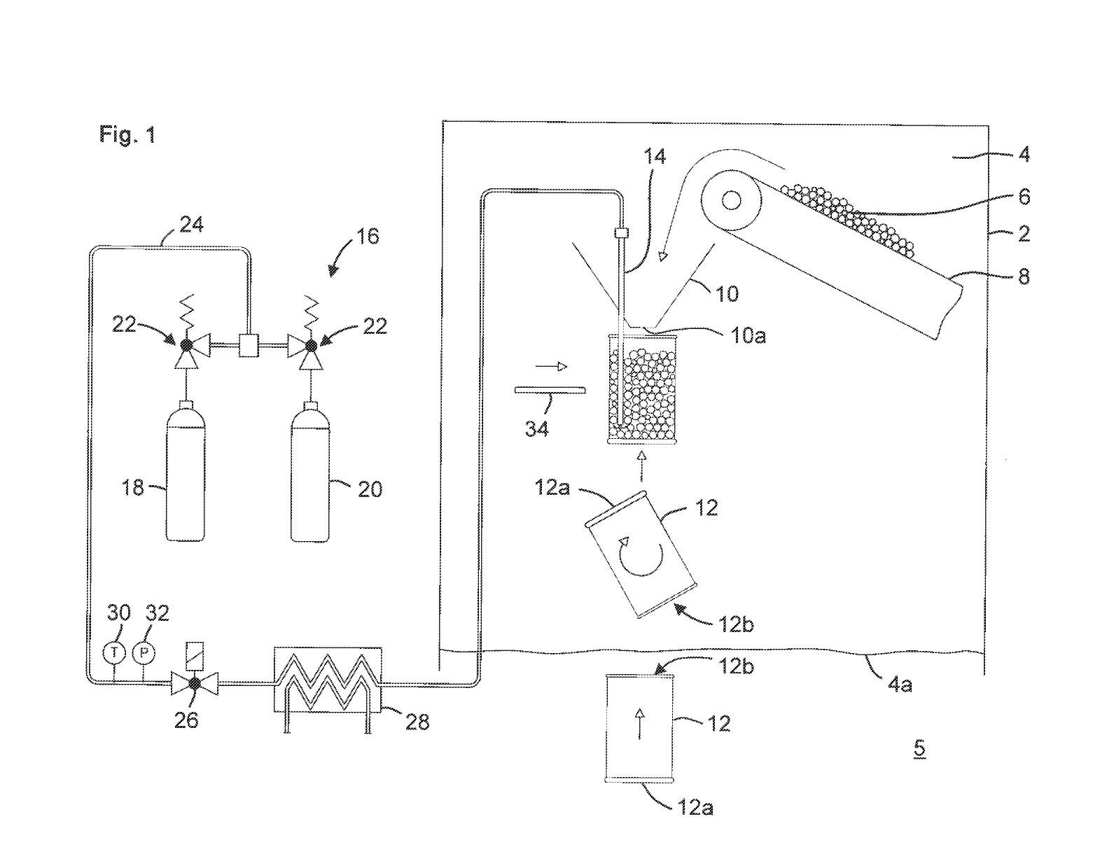

With reference to FIG. 1, a chamber 2 comprises a superheated steam atmosphere 4 having a temperature above 100° C. by, for example, heating system (not illustrated). The pressure in the chamber 2 may be atmospheric, i.e. generally 1000 mbar. The oxygen content of the steam atmosphere 4 may comprise less than 10 vol.-% of O₂, and further, less than 3 vol.-%. The chamber 2 can further comprise a boundary layer 4a between steam atmosphere 4 and the ambient air 5.

A product 6, such as, for example, a food product, is transported by transport equipment 8 into the chamber 2 and further into a product funnel 10. Before entering the product funnel 10, the product 6 may be dried to a predetermined moistness, such as, for example, to an a_{w}-value of 0.9 or less, which may reduce or prevent the cultivation of microorganisms within the packed condition. In various embodiments, the product 6 dwells in the steam atmosphere 4 for a sufficient time period to dry the product to the desired an a_{w}-value before transport to product funnel 10.

The product passes through an opening 10a of product funnel 10 and into a packing container 12, which may be positioned under the product funnel 10. The packing container 12 can comprise a bottom 12a and a seal opening 12b which is located directly under the opening 10a.

The packing container 12 can comprise, for example, a plastic bag, which may be formed within the chamber 2 from a film material. Further, packaging container 12 can comprise a can or a receptacle with a cap or a lid configured to seal the packaging container 12. In various embodiments, a rigid packing container 12 is conveyed from outside of housing 2 into the steam atmosphere 4 in an upside-down position, in which the bottom 12a points upwards and the seal opening 12b downwards. In this position, ambient air contained in the packing container 12 may escape due to gravity, while the internal volume of the packing container fills with steam atmosphere.

The packing container 12 can then be transported into a filling position, in which it is filled with product. In the filling position gas supply pipe 14 extends into the packing container 12, whereby a gas discharge opening located at the end of gas supply pipe 14 is positioned at or near the bottom 12a of the packing container 12.

In various embodiments, gas supply pipe 14 is connected to a gas injector 16, which can comprise a pressure cylinder 18 and/or a pressure cylinder 20. One or both of pressure cylinders 18, 20 can be filled with one or more sterile inert gas. For example, pressure cylinder 18 can be filled with N₂, pressure cylinder 20 filled with CO₂. The pressure cylinders can further comprise a pressure control valve 22, a manifold 24, a solenoid valve 26, a heating station 28, as well as temperature gauge 30, and pressure gauge 32. Gas injector 16 is provided with a control unit (not illustrated), which can act on the pressure control valves 22, solenoid valve 26, and heating station 28, in order to control the supply timing, the quantity, the composition and the temperature of the gas mixture fed to gas supply pipe 14.

In various embodiments, product 6 is fed via transport device 8 or alternatively directly through an extruder into chamber 2 and steam atmosphere 4. Depending on the drying requirement, the product is exposed for a certain time to the steam atmosphere 4 and thereby dried. Subsequently, the product is transported to the product funnel 10, and further, into an available packing container 12.

Packing container 12 is conveyed into the chamber by, for example, transport equipment, rotated there by 180° or conveyed into the chamber already in the rotated position, so that the bottom 12a points upwards, and then rotated by 180°, so that the seal opening 12b points upwards, and brought into the filling position. The gas supply pipe can then be located in packing container 12 before it is filled with product.

Subsequently, packing container 12 can be filled with product 6, such as a lumpy or a granular-type food product. The volume or bulk volume of filled product 6 can comprise at least 50%, 60%, 70%, 80%, 90%, 95% or 99% of the fillable internal volume of packing container 12.

Before, during or after filling the product into the packing container, a sterile gas, such as, for example, a mixture of N₂ and CO₂, is injected through gas supply pipe 14 into packing container 12, and a residual volume of steam atmosphere is expelled from packing container 12 and/or replaced by the sterile gas. In the case of a lumpy or granular-type product 6, a residual volume of steam atmosphere can exist between the individual pieces of product 6. By disposing the gas discharge opening directly above bottom 12a of packing container 12, the remaining steam atmosphere can be expelled to a large extent from between the individual food pieces.

In various embodiments, packing container 12 is lowered or gas supply pipe 14 is raised, so that gas supply pipe 14 is located outside packing container 12. Packing container 12 can then be moved horizontally to a sealing station, in which packing container 12 is sealed as to be gas-tight, particularly by applying and sealing a lid 34. The sealing station is preferably disposed within chamber 2 in order to avoid contact with ambient air.

After being sealed, packing container 12 is removed from chamber 2 by, for example, transport equipment (not illustrated) and either cooled down in a cooling device in accordance with a predetermined time-temperature profile or cooled down only by leaving to stand in the environment.

Reference symbol list

| | |
|---|---|
| 2 | Chamber |
| 4 | Steam atmosphere |
| 4a | Boundary layer |
| 5 | Ambient air |
| 6 | Product |
| 8 | Transport equipment |
| 10 | Product funnel |
| 10a | Opening |
| 12 | Packing container |
| 12a | Bottom |
| 12b | Seal opening |
| 14 | Gas supply pipe |
| 16 | Gas injector |
| 18 | N₂ pressure cylinder |
| 20 | CO₂ pressure cylinder |
| 22 | Pressure control valve |
| 24 | Manifold |
| 26 | Solenoid valve |
| 28 | Heating station |
| 30 | Temperature gauge |
| 32 | Pressure gauge |
| 34 | Lid |

What is claimed:

1. Method for the manufacture of a packed product, comprising the steps of:
bringing a product into a superheated steam atmosphere with an O₂ content of maximum 10 vol.-%, a pressure of between 950 mbar and 1100 mbar and a temperature of at least 100° C.;
making available a packing container in the superheated steam atmosphere and filling the packing container with a predetermined quantity of the product, wherein a residual volume of the packing container not filled with product is filled with the superheated steam atmosphere;
replacing at least 50% of the residual volume of superheated steam atmosphere in the packing container by a sterile inert gas, wherein the inert gas is heated to a temperature of at least 60° C., 80° C., 100° C. or to the temperature of the superheated steam atmosphere;
sealing the packing container; and
cooling the packing container and the product contained therein.

2. The method of claim 1, wherein the product is dried in the superheated steam atmosphere to an a_{w}-value of 0.9 or less, before it is filled into the packing container.

3. The method of claim 1, wherein the packing container comprises a rigid packaging container, and wherein after cooling to a temperature of 20° C., the pressure within the rigid packaging container comprises one of 500 mbar, 550 mbar, 600 mbar, 650 mbar, 700 mbar, 750 mbar, 800 mbar, 850 mbar or 900 mbar.

4. The method of claim 1, wherein at least 55%, 60%, 65%, 70%, 75%, 80%, 85%, 90% or 95% of the residual volume of superheated steam atmosphere in the packing container is replaced by the inert gas.

5. The method of claim 1, wherein the step of replacing at least 50% of the residual volume of superheated steam atmosphere is implemented within the superheated steam atmosphere.

6. The method of claim 1, wherein the inert gas comprises N₂, CO₂, N₂O, CO, H₂ or a mixture therein.

7. The method of claim 7, wherein the gas comprises a mixture of N₂ and CO₂ with at least 10 vol.-%, 20 vol.-%, 30 vol.-%, 40 vol.-%, 50 vol.-%, 60 vol.-%, 70 vol.-%, 80 vol.-% or 90 vol.-% of CO₂.

8. The method of claim 1, wherein the packaging container comprises a receptacle having screw-cap, a can, or a plastic bag.

9. The method of claim 1, wherein the superheated steam atmosphere comprises an O₂ content of less than 7.5 vol.-%, 5 vol.-%, 3 vol.-% or 1 vol.-%.

10. The method of claim 1, wherein the product is dried in a superheated steam atmosphere with a temperature of at least 110° C., 120° C., 130° C. or 150° C.
